(19) United States
(12) Patent Application Publication
(10) Pub. No.: US 2015/0084393 A1
(43) Pub. Date: Mar. 26, 2015

(54) Portable Armrest Divider

(71) Applicants: Arthur Chang, Arlington (TX); Grace Chang, Arlington, TX (US)

(72) Inventors: Arthur Chang, Arlington (TX); Grace Chang, Arlington, TX (US)

(21) Appl. No.: 14/033,453

(22) Filed: Sep. 21, 2013

(51) Int. Cl. A47C 7/54; B60N 2/46

(52) U.S. Cl. CPC A47C 7/546; B60N 2/4673
USPC 297/411.23

(57) ABSTRACT

A portable armrest divider is disclosed that is mounted on a vehicle armrest and expands the surface area of the original armrest, while providing a vertical separation barrier between the two individuals seated on either side of the armrest. The armrest is portable, in that it folds in half for easy travel.

### TECHNICAL FIELD OF THE DISCLOSURE

The present disclosure relates generally to the field of furniture, specifically chairs with armrests.

### BACKGROUND OF THE DISCLOSURE

Row seating is employed in airplanes, movie theaters, waiting rooms, and other similar locations. Their great advantage is that they provide seating for large numbers of people in close proximity of each other.

A major disadvantage of row seating as currently offered by the industry is that the armrests are narrow and is difficult to use at the same time for both people sitting in the seats on both sides of the armrests.

Another disadvantage is that these armrests are unsanitary. Though common practice is to wipe them down between movies when there is some obvious evidence of a need, e.g., some sort of liquid on the material, these armrests can go entire days without proper cleaning.

Travelers often seek some method to expand the space they take while on planes. For these individuals, the size of the armrest is nearly irrelevant—they want to take it all. For the passengers unlucky enough to be seated next to such people, travel can be very uncomfortable. Faced with pushing back against a large and often unruly individual is socially awkward and uncomfortable to many people, who tend to just tolerate the boorish behavior rather than risk an even more unpleasant plane flight by adding a tense conversation.

The frequent traveler needs a device that can increase the armrest size available to him, provide some simple barrier to the spatial encroachments by his neighbors, and ensure a sanitary surface on which to rest his arms and elbows.

### SUMMARY OF THE DISCLOSURE

The present disclosure a portable armrest divider for use by those in row seating who desire armrests that are wider, more sanitary, or have a separation than the installed armrests provide.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description of the disclosure along with the accompanying figures in which corresponding numerals in the different figures refer to corresponding parts and in which:

FIG. 1 is a perspective view of the Armrest Divider 100.

FIG. 2 is the second perspective view as FIG. 1, viewed more closely than in FIG. 1.

FIG. 3 is a third perspective view of the Armrest Divider.

FIG. 4 is a perspective view of the Armrest Divider 100 partially folded.

FIG. 5 shows a perspective view of the Armrest Divider 100 with optional embodiment including a Divider Strap 200.

FIG. 6 shows a front view of the Armrest Divider 100.

FIG. 7 shows a front view of the Armrest Divider 100 in the folded position (not including Mounting Strap 140 and Adjustable Buckle 150).

FIG. 8 contains a legend for the drawings.

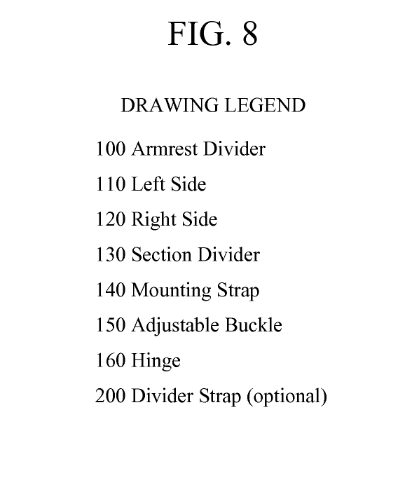

### DETAILED DESCRIPTION OF THE DISCLOSURE

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of a folding Portable Armrest Divider 11. The specific embodiment discussed herein is, however, merely is illustrative of specific ways to make and use the disclosure and do not limit the scope of the disclosure to the specific context disclosed.

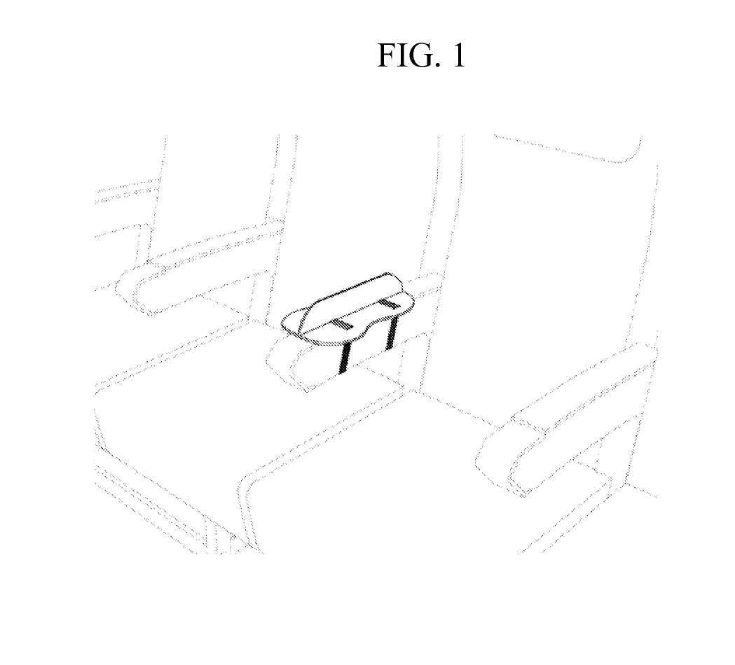

FIG. 1 shows a perspective view of the installed Armrest Divider.

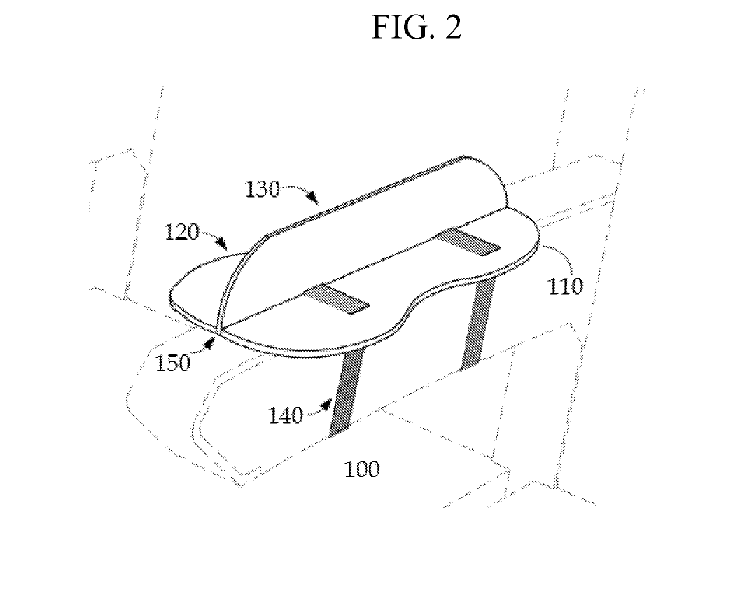

FIG. 2 shows the same perspective view of one embodiment of the installed device. This embodiment comprises three flat surfaces 110, 120, 130 connected by a Hinge 160 on one straight side where they meet.

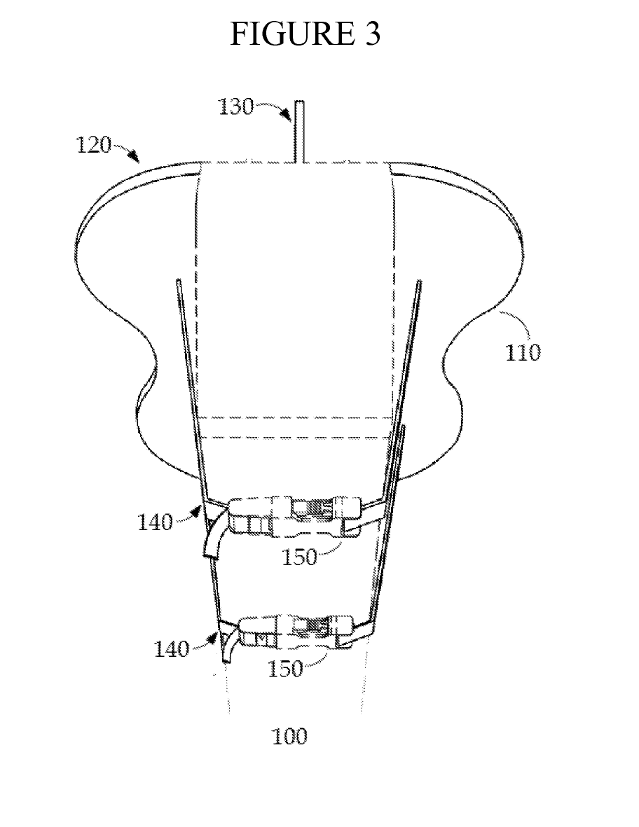

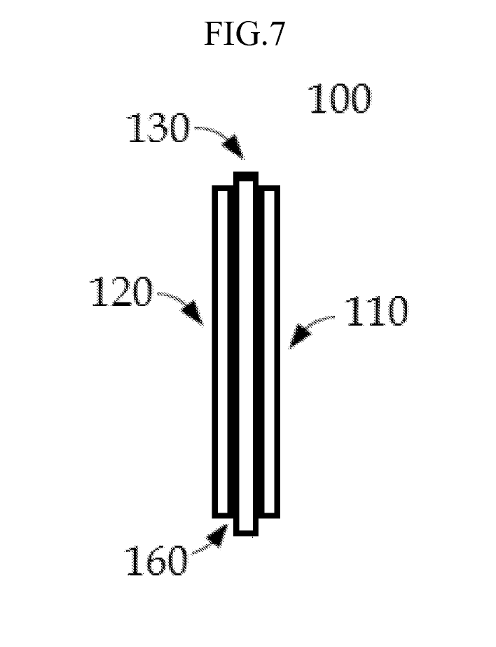

In the embodiment shown in the figures, the Left Side 110 and Right Side 120 are mirror images of each other, with the Section Divider 130 connectedly hinged between them so they can be folded together as a three-page book, as shown in FIG. 7, or opened fully as in FIGS. 1-3, 5, and 6, so the Left Side 110 and Right Side 120 lay flat on either side of the Section Divider 130, which acts as a middle page that is constructed to rigidly extend upwards when the Armrest Divider 100 assembly is in an open position.

The Armrest Divider 100 is typically mounted on a vehicle armrest, and held in place by two adjustable Mounting Straps 140 that extend from the exterior Sides 110, 120 of the is Armrest Divider 100, down and around the vehicle's stock armrest, and fixed in place by an Adjustable Buckle 150 below the armrest.

The Armrest 100 is currently built using flat inelastic Mounting Straps 140 in conjunction with the Adjustable Buckle 150, but an alternative embodiment could use elastic Mounting Straps 140 and a non-adjustable buckle, or even just elastic loops that fit over a seat's armrest to hold them in place.

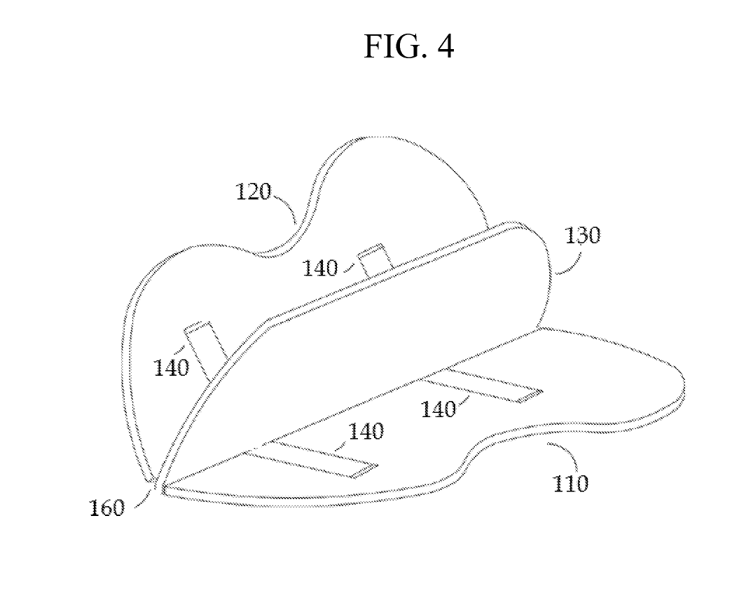

FIG. 4 shows the invention partially closed. This drawing shows a particular location for the Mounting Straps 140 going through slots in the Right and Left Sides 110, 120. (This drawing does not show the lower portion of the straps.) A person with ordinary skill in the art could locate the Mounting Straps 140 in several locations, and use the two straps as shown, or use a different number or type of straps.

Though the Left Side and 110 and Right Side 120 are mirror images in this embodiment, the invention does not require that the two sides be alike. The three parts of the Armrest Divider 100 can be all three alike, or substantially different, except that all three of the major components must is attach together on one side.

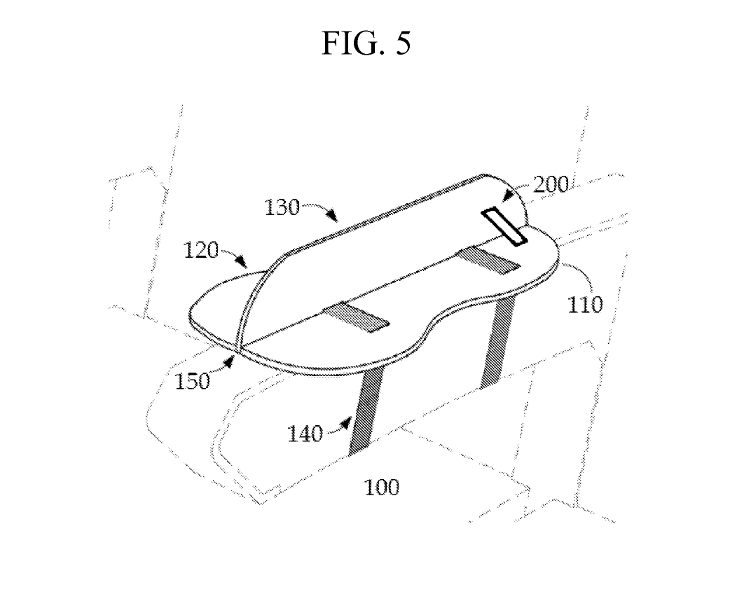

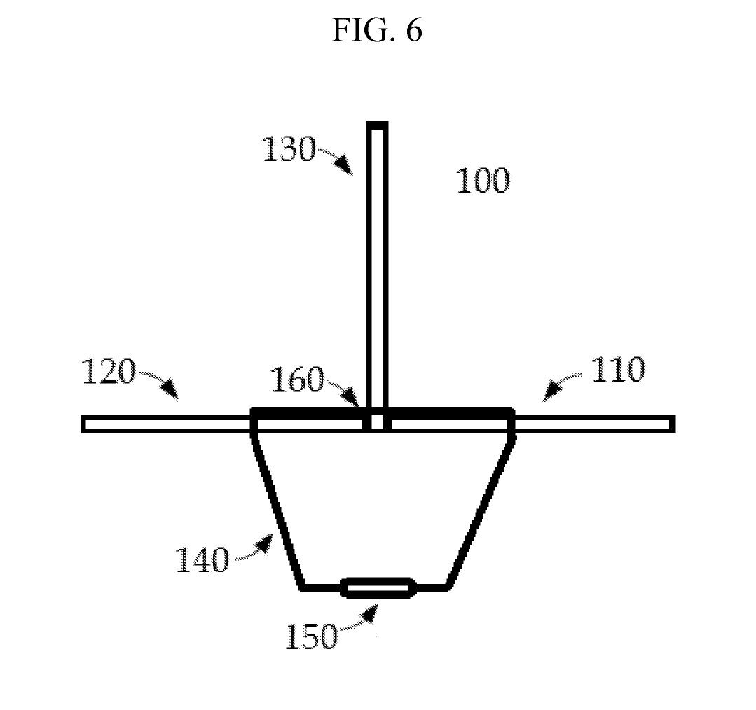

The Armrest Divider 100 must be constructed to hold the central Divider Section 130 vertically in place. There are many means for holding the Divider Section vertical, including the use thick, hinged surfaces as demonstrated and shown in FIGS. 6 and 7, or using Divider Straps 200 that keep the Section Divider 130 upright when the sides are open, as shown in FIG. 5. The applicant asserts that a person having ordinary skill in the art could employ a multitude of constructions of the Armrest Divider 100 that allow it to close into an essentially flat product, and open such that the Section Divider 130 is held upright when the Left and Right Sides 110, 120 are opened.

As the Armrest Divider 100 is currently constructed, a user mounts the invention by: 1) opening the Left and Right Sides 110 and 120, 2) locating the Armrest Divider 100 on top of the armrest on which the Armrest Divider 100 is to be mounted, 3) joining the two ends of the Mounting Straps 140 under the armrest using the Adjustable Buckle 150, and 4) tightening the Mounting Straps 140 so the Armrest Divider 100 is held in place.

To remove the Armrest Divider 100 from a mounted position on a vehicle armrest, a user simply releases the Adjustable Buckle 150, folds the Armrest Divider 100, and picks up the folded Armrest Divider 100 for storage.

It is considered within the ambit of one skilled in the art to construct an Armrest Divider 100 that uses other methods of holding the invention in place. For example, for row seats that have a construction disallowing the straps from encircling the stock armrest, a set of fold-out rails that extend from the bottom of the Left and Right Sides 110 and 120, or a pair of spring-loaded clamps attached at the ends of the device that extend down and grasp the stock armrest.

What is claimed is:

1. An Armrest Divider comprising:
a) a first rigid flat surface (the “Section Divider”) constructed with at least one straight edge;
b) a second rigid flat surface (the “Right Side”) constructed with a straight edge that matches the straight edge of the first rigid flat surface;
c) a third rigid flat surface (the “Left Side”) constructed with a straight edge that matches the straight edge of the first and second surface;
d) a means for hingedly connecting the matching straight edge of the three aforementioned surfaces such that:
i) the three surfaces can reach a flat “Closed” position, similar to a book, with the Section Divider positioned between the Left and Right Sides, and the Left and Right Sides each have an exterior face and an interior face;
ii) the connection between the three surfaces allows the Left Side and Right Side to reach an “Open” position, in which the hinged surfaces are open to create a 180°-angled flat surface, with the Section Divider centered between the Left and Right Sides, and held vertical and perpendicular to the Sides;
e) One or more pairs of Mounting Straps extending from the exterior faces of the Left and Right Sides.

2. An Armrest Divider as in claim 1 in which the pairs of Mounting Straps are replaced by an elastic loop.

3. An Armrest Divider as in claim 1 in which a paper binding serves as the hinge between the three flat surfaces.

4. An Armrest Divider as in claim 1, additionally comprising one or more Buckles, each of which connect together a pair of Mounting Straps.

5. An Armrest Divider as in claim 4, in which the Buckles can be used to adjust the length of the Mounting Straps.

6. An Armrest Divider as in claim 1 in which the pairs of Mounting Straps is supplemented or replaced by a pair of rigid guides extending vertically downward that straddle the chair's armrest.

7. A method of increasing the effective surface area of a chair's armrest by attaching a flat rigid surface (“Armrest Divider”) on top of the armrest.

8. The method of claim 7, in which the Armrest Divider is mounted to a chair's armrest by:
a) placing the Armrest Divider on top of the armrest;
b) using a flexible lash to affix the Armrest Divider to the chair's armrest by placing the lash around the bottom of the chair's armrest; and
c) removing slack from the lash until the Armrest Divider is fixed in place.

9. The method of claim 8, in which the Armrest Divider comprises a foldable surface, with the additional step of unfolding the Armrest Divider prior to placing it on top of the armrest.

10. The method of claim 7 in which the flat rigid surface is affixed to the chair's armrest by clamps on the ends of the surface, or rigid guides extending from the surface to straddle the armrest.
